(19) United States
(12) Patent Application Publication
(10) Pub. No.: US 2010/0032600 A1
(43) Pub. Date: Feb. 11, 2010

(54) PNEUMATIC VALVE CONTROL ASSEMBLY

(75) Inventors: Steve Doe, Jacksonville, AL (US); William M. Cost, Hartselle, AL (US); Kenneth E. Reid, II, Oxford, IL (US); Glenn S. Geis, Hunstville, AL (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 12/513,911

(22) PCT Filed: Nov. 9, 2007
(86) PCT No.: PCT/US2007/084249

§ 371 Date: May 7, 2009

Related U.S. Application Data
(60) Provisional application No. 60/865,013, filed on Nov. 9, 2006.

(51) Int. Cl. F16K 31/02; F16K 51/00

(52) U.S. Cl. 251/129.15; 137/15.18

(57) ABSTRACT

A pneumatic control valve assembly for a sample conditioning system used to condition one or more fluid streams to be analyzed. A pneumatic valve control assembly comprises a housing being attachable to an enclosure of the sample conditioning system at a first interface. The assembly includes at least one electrically operated pneumatic solenoid valve located in the housing and adapted to controllably supply pressurized air through a flow passage extending through the first interface to a respective pneumatically controlled valve located in the conditioning system enclosure to operate the pneumatically controlled valve. The assembly includes electronic circuitry located in the housing and having at least one relatively high voltage control circuit for controlling power supplied to the solenoid valve.

### CROSS-REFERENCE TO RELATED APPLICATIONS

The present application claims the benefit of the filing date of U.S. Provisional Application Ser. No. 60/865,013, filed Nov. 9, 2006, which is incorporated by reference in its entirety.

### TECHNICAL FIELD

The present invention provides a pneumatic valve control assembly suitable for use with process analyzers. In particular, the present invention provides a pneumatic valve control assembly for providing pneumatic signals and optionally electrical signals to one or more components located in a sample conditioning system and a sample conditioning system employing such an assembly.

### BACKGROUND

Process analyzers, such as gas chromatographs, spectrophotometers, and the like, are utilized to analyze various types of fluid process streams including but not limited to hydrocarbon based fluids.

An analyzer system typically includes the analyzer itself and a sample conditioning system. The sample conditioning system includes an enclosure that houses stream selectors (also referred to as stream switching valves) and sensors. The stream selectors control the flow of a fluid into the analyzer. The selector selects a single sample from multiple flow streams (such as from a fluid stream of interest, a calibration stream, or the like) to pass on for analysis. This reduces the cost of analyzing multiple gas and liquid process streams in a manufacturing or laboratory facility, as each analyzer is relatively expensive. The stream selector includes a series of valves that are typically electrically controlled. Typically, a common outlet header is connected to each valve to route the selected sample stream to the analyzer, and only one sample should be routed through the header to the analyzer at one time.

The stream selectors are typically controlled by pneumatic solenoid valves. The solenoid valves are electrically operated and coupled to a stream selector valve to provide a pneumatic signal to open or close the stream selector.

In many instances, gas or fluid streams being analyzed may be combustable, and the interior or enclosure of a sample conditioning system (through which such gases pass) may contain a combustable mixture of such fluids. Consequently, high voltage devices, such as the solenoid valves, cannot be placed inside or even in close proximity to the sample conditioning system enclosure as sparking from such devices may result in an explosion. The sample conditioning system may include electrically operated devices such as sensors to monitor the conditions of the enclosure itself (e.g., pressure, temperature, percent O₂, etc.), and/or conditions of the process streams (e.g., pressure, temperature, flow rate, etc.). These sensors, however, are typically provided as explosion proof devices. The high voltage solenoid valves, on the other hand, are typically located relatively distant from the sample conditioning system. Often, the solenoids are located within the analyzer, which is located in a shelter. Further, the environment within the analyzer shelter is purged to remove potentially explosive gases. To connect the solenoid valves to the stream selectors, a system must be designed such that the appropriate tubing and conduits to deliver the pneumatic signals must penetrate multiple walls including the analyzer walls, the walls of the shelter housing the analyzer, and the walls of the sample conditioning system. Additionally, locating solenoids in the analyzer makes it difficult for operators to monitor the system and determine if the solenoid valves are functioning properly or which valve may be experiencing problems.

### SUMMARY

The present invention provides a pneumatic control valve assembly that is suitable for providing pneumatic signals and/or electrical signals to components located in a sample conditioning enclosure and is attachable to the sample conditioning system.

The present invention also provides a pneumatic control valve assembly such that the interior of the assembly is fluidically isolated from the exterior so as to prevent the ingress of gases or other combustable fluids into the assembly.

In one aspect, the present invention provides a pneumatic valve control assembly for a sample conditioning system used to condition one or more fluid streams to be analyzed, the pneumatic valve control assembly comprising a housing being attachable to an enclosure of the sample conditioning system at a first interface; at least one electrically operated pneumatic solenoid valve located in the housing, the solenoid valve having an inlet for connection to a source of pressurized air and an outlet connected to a flow passage extending through the first interface whereby pressurized air can be controllably supplied to a respective pneumatically controlled valve located in the enclosure of the sample conditioning system for pneumatically operating the pneumatically controlled valve; and electronic circuitry located in the housing, the electronic circuitry including at least one relatively high voltage control circuit for controlling power supplied to the solenoid valve.

The housing may be attachable to the sample conditioning enclosure at the first interface through a manifold body having passages extending therethrough and in fluid communication with a passage or opening of each of the housing and the sample conditioning system enclosure.

The manifold body may be mounted to the housing through an opening of the housing. The assembly may include a seal member disposed about the manifold body to provide a fluidic seal to prevent the ingress of fluids into the assembly housing.

The assembly may be mounted to the sample conditioning system by mounting a forward end of the manifold body through an opening of the sample conditioning system enclosure.

The electronic circuitry may also include at least one relatively low voltage circuit connected to a lead that passes through a second interface for connection to at least one low voltage component located in the enclosure of the sample conditioning system. The second interface may also be sealed to prevent the ingress of fluids into the housing at the second interface.

In another aspect, the present invention provides a sample conditioning system for use in a chemical or other process facility for obtaining samples from one or more fluid streams to be analyzed, the system comprising an enclosure having an interior and an exterior, an opening through a wall thereof, and one or more pneumatically controlled valves; and a pneumatic valve control assembly comprising: a housing being attachable to the enclosure of the sample conditioning system at a first interface; at least one electrically operated pneumatic solenoid valve located in the housing, the solenoid valve having an inlet for connection to a source of pressurized air and an outlet connected to a flow passage extending through the first interface whereby pressurized air can be controllably supplied to a respective pneumatically controlled valve located in the enclosure of the sample conditioning system for pneumatically operating the pneumatically controlled valve; and electronic circuitry located in the housing, the electronic circuitry including at least one relatively high voltage control circuit for controlling power supplied to the solenoid valve. The electronic circuitry may also include at least one relatively low voltage circuit connected to a lead that passes through a second interface for connection to at least one low voltage component located in the enclosure of the sample conditioning system.

In still a further aspect, the present invention provides a method of attaching a pneumatic control valve assembly to a sample conditioning system used for conditioning one or more fluid streams to be analyzed, the method comprising: providing a pneumatic control valve assembly comprising a housing and having (i) at least one electrically operated pneumatic solenoid valve, and (ii) electronic circuitry located within the housing, the solenoid valve having an inlet for connection to a source of pressurized air and an outlet for supplying pressurized air, the electronic circuitry including at least one relatively high voltage control circuit for controlling power supplied to the solenoid valves, and at least one relatively low voltage circuit connected to a lead; attaching the housing to an enclosure of the sample condition at a first interface, the first interface having a flow passage extending therethrough, the pressurized air being controllably supplied through the first interface to a respective pneumatically controlled valve located in the enclosure; and passing the lead connected to the low voltage control circuit through a second interface for connection to at least one low voltage component located in the enclosure of the sample conditioning system.

These and other features of the invention will become apparent from the following detailed description when considered in conjunction with the drawings.

### BRIEF DESCRIPTION OF THE DRAWINGS

In the annexed drawings:

FIG. 1 is a front view looking into the interior of an exemplary sample conditioning system and the interior of an exemplary pneumatic valve control assembly in accordance the present invention that is attached to the sample conditioning system;

FIG. 2 is a front view of the exemplary pneumatic valve control assembly from FIG. 1;

FIG. 3 is a perspective of an exemplary manifold body for attaching a pneumatic control valve assembly to a sample conditioning system enclosure;

FIG. 4 is a side elevational view of the manifold body of FIG. 3;

FIG. 5 is a cross-sectional view of the manifold body of FIGS. 3 and 4 taken along the line 5-5;

FIG. 6 is close-up view of the first interface showing the manifold body attached to the assembly housing and the assembly housing attached to the sample conditioning system enclosure; and

FIG. 7 is a cross-sectional view of FIG. 6.

### DETAILED DESCRIPTION

Certain terminology may be employed in the description to follow for convenience rather than for any limiting purpose. For example, the terms forward, rearward, right, left, upper, and lower may designate directions in the drawings to which the reference is made, and the terms inward, interior, inner, or inboard, and outward, exterior, outer, or outboard may refer, respectively, to directions toward and away from the center of the referenced element, and the terms axial and radial may refer, respectively, to directions perpendicular and parallel to the central longitudinal axis of the referenced element. Terminology of similar import other than the words specifically mentioned above likewise is to be considered as being used for purposes of convenience rather than in a limiting sense.

A pneumatic control valve assembly in accordance with the present invention may be employed in an analyzer system for analyzing fluid streams. A pneumatic control valve assembly in accordance with the present invention may be attached to a sample condition system enclosure and provide pneumatic signals across a first interface to one or more stream selectors. The assembly may also be configured to provide electrical signals across a second interface to one or more electronic components located within the sample conditioning system enclosure.

Generally, a sample conditioning system in accordance with the present invention includes a sample conditioning enclosure (for receiving and conditioning a fluid process stream to be analyzed) and a pneumatic valve control assembly. The pneumatic valve control assembly includes a housing that is attachable to the enclosure at a first interface between the housing and the enclosure of the sample conditioning system. Passages extend through the first interface to provide a pathway for a pneumatic signal (e.g., pressurized air) from a pneumatic valve located in the assembly housing to a pneumatically controlled valve located in the sample conditioning enclosure. The pneumatic valve control assembly may also include a passage at a second interface through which leads that are connected to a relatively low voltage circuit pass from the assembly housing to the sample conditioning system enclosure for connection to a low voltage component. The sample conditioning system is attachable to the sample conditioning enclosure at the first interface, and may be attachable at the second interface.

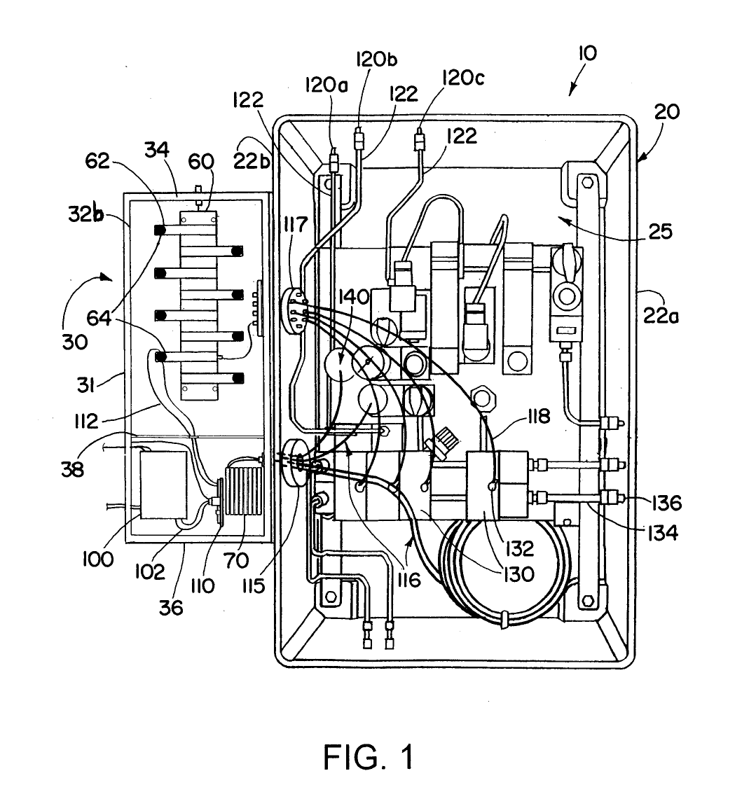

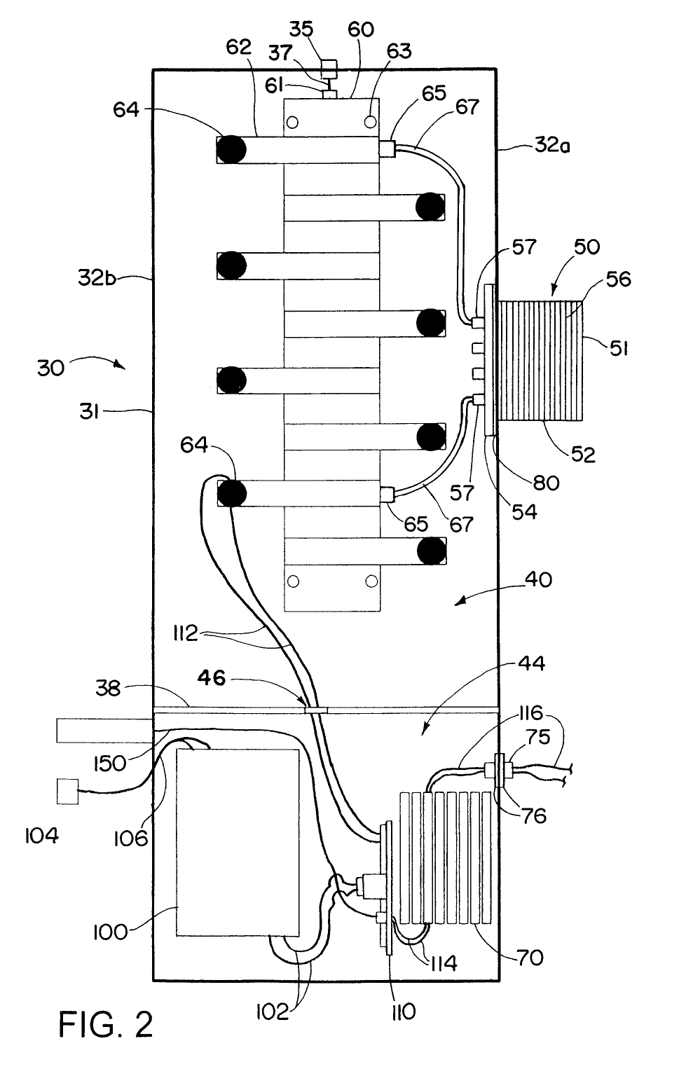

FIG. 1 illustrates an exemplary sample conditioning system 10 comprising a sample conditioning enclosure 20 and an exemplary pneumatic valve control assembly 30 attached to the enclosure 20. As shown in FIGS. 1 and 2, the pneumatic control valve assembly 30 includes a housing 31 having sidewalls 32a and 32b, a top wall 34, and a bottom wall 36. The assembly 30 defines an interior region 40, and the walls (e.g., sidewalls 32a and 32b, and front and back walls) separate the interior 40 from the exterior. The pneumatic valve control assembly 30 includes electrically operated pneumatic solenoid valves 62 located within the housing 31. The housing 31 is attached to the enclosure 20 at a first interface, and pressurized air is supplied through a flow passage extending through the first interface to a pneumatically controlled valve (e.g., stream switching valve 130) located in the interior 25 of enclosure 20. The pressurized air controls the opening and closing of valves 130 to selectively supply a process fluid received from inlets 120a, 120b, and 120c through inlet lines 122 through an output line 134 and out an outlet 136 to an analyzer.

The housing 30 may be attached to the enclosure 20 at the first interface by a mounting member such as a manifold body 50 having a forward end 51 and a rearward end 53. Referring to FIGS. 5 and 7, the manifold body includes passages 58 extending through the manifold body from the forward end of the manifold body to the rearward end. The passages 58 define openings 59 along the surfaces of the forward and rearward ends (51 and 53, respectively) of the manifold body. The passages provide a pathway for pressurized air to be sent from the solenoid valves 62 located in the assembly housing to a pneumatically controlled valve 130 located in the interior of the sample conditioning enclosure to which the pneumatic control valve assembly is attached.

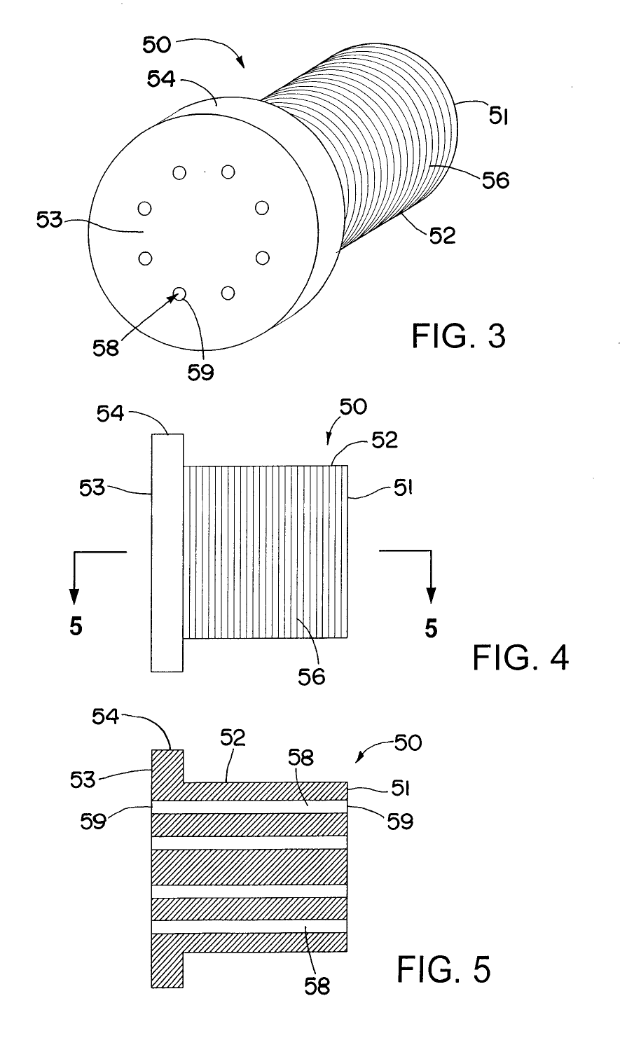

The manifold body 50 may be configured for mounting to the assembly housing 31 in any suitable manner. For example, the manifold body may be designed to fasten the manifold assembly to the housing. As shown in FIGS. 2-7, manifold body 50 includes a bulkhead portion 52 and a flange portion 54. Referring to FIG. 7, the manifold body 50 is shown as being disposed through an opening 33 extending through wall 32a of the assembly housing. The manifold body is disposed through the opening 33 such that the flange portion 54 is located in the interior of the assembly housing, and at least a portion of the bulkhead assembly is disposed on the exterior of the assembly housing. The flange portion 54 of manifold body 50 is sized such that it has an extent larger than the opening 33 of the wall 32a. As shown in FIGS. 3, 4, and 6, the bulkhead portion 52 of manifold body is provided with a threaded surface 56. As shown in FIG. 5, the manifold body may be secured to the assembly housing by a fastener 90a (e.g., a spanner nut or the like) that is threaded onto the threaded exterior 56. If desired, a seal member 82 may be disposed between the fastener 90a and the outer portion of the wall 32a. As the fastener 90a is tightened, the bulkhead portion is held in place between the fastener 90a and the flange portion 54.

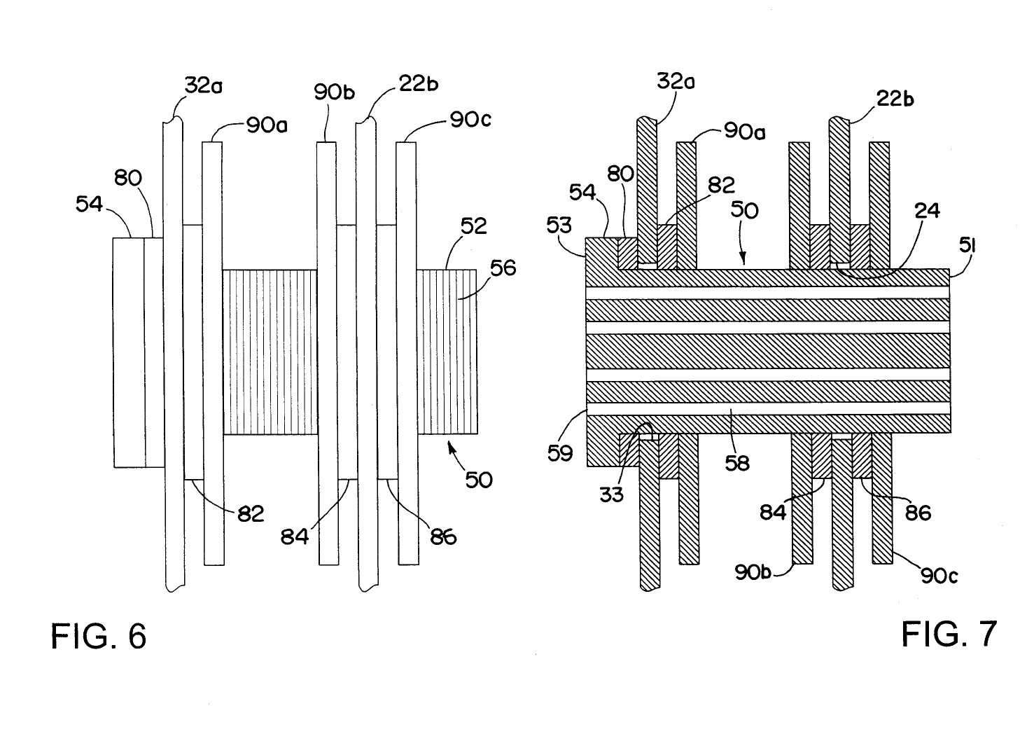

As shown in FIGS. 6 and 7, a seal member 80 is disposed between the flange portion 54 and the interior portion of wall 32a. The seal member 80 provides a fluidic seal between the exterior and interior of the assembly housing and prevents the ingress of gases and fluids into the assembly housing at the first interface. The seal members (e.g., 80, 82, 84, and 86) may be rubber seals or seals formed from any suitable polymeric material that is capable of providing a fluidic seal.

Referring to FIGS. 4 and 5, the flange portion 54 is shown as being integral with the bulkhead portion 52 and forms the rearward end of the manifold body. It will be appreciated that the flange portion 54 need not form the rearward end of the manifold body and may be displaced from the rearward end of the manifold body. Additionally, it will be appreciated that the flange portion need not be integral with the bulkhead portion but may be a separate structure connected to or disposed on the bulkhead portion. For example, the flange could be provided by a fastener similar to fastener 90a.

The assembly housing 31 is attachable to the sample conditioning system at the first interface. The first interface is the location where the housing 31 and the enclosure 20 meet such that the housing 31 and enclosure 20 are connectable in fluid communication with each other. The interface may be provided by passages or openings (e.g., opening 33 in housing 31 and opening 24 in enclosure 20, as shown in FIG. 7). The housing 31 may be attached to the sample conditioning enclosure 20 at the first interface via manifold body 50. As shown in FIGS. 6 and 7, the forward end 51 of the manifold body may be disposed through an opening 24 and into the interior 25 of the sample conditioning system enclosure. The manifold body may be secured to the sample conditioning system by a fastener 90c threaded onto the threaded surface 56 of manifold body 50. A seal or gasket may be disposed between the interior portion of wall 22b and the fastener 90c.

If desired, an additional fastener may be used to secure the housing assembly to the sample conditioning system. As shown in FIGS. 6 and 7, a fastener 90b may be disposed on the exterior of the sample conditioning system and threaded to provide a tightened engagement with the wall 22b of the sample conditioning system. A seal member 84 may be disposed between the fastener 90b and the exterior of the wall 22b on the sample conditioning system. The fastener 90b may be used to control or adjust the spacing between the assembly housing 32 and the sample conditioning enclosure 20.

The assembly is adapted to provide pneumatic signals to components in the sample conditioning system through the first interface. The assembly 30 includes solenoid valves 62 disposed within the interior region of the assembly housing. The solenoids may be mounted to a solenoid manifold 60, which may be mounted to the back wall of the assembly housing (such as by a fastener inserted through aperture 63 of the solenoid manifold). The assembly housing 31 includes an inlet 35 for connection to a source of pressurized air. It will be appreciated that “pressurized air” or “air” encompasses any gas (e.g., air, nitrogen, etc.) suitable for controllably operating the pneumatically controlled valves, e.g., the stream switching valves, located in the sample conditioning system enclosure. The inlet 35 is connected to an inlet 61 on the solenoid manifold 60 through line 37. The inlet 61 is in fluid communication with a channel (not shown) in the solenoid manifold 60 that supplies the pressurized air to the solenoid valves 62. The pressurized air is supplied through an outlet on the respective solenoid valves to a corresponding passage through a conduit 67 (e.g., Teflon tubing). The conduit may be connected to an appropriate connector element or fitting attached to the outlet(s) on the solenoid valves and the opening(s) on the manifold body. For example, conduit 67 may be attached to connector/fittings 57 and 65, respectively. The connector elements may be any suitable connector such as, for example, a press fit connector or a threaded connector element (if the outlet on the solenoid valve or the ends of passages 58 are provided with a threaded surface). The solenoid valves may be any suitable valve as desired for a particular purpose or intended use. A particularly suitable solenoid valve is a three-way pneumatic solenoid valve.

The solenoid valves are electrically operated. The solenoid valves include a terminal 64 connected to a control circuit 110 through transmitter wires 112. Upon receiving an electrical signal from control circuit 110 (which receives power from power supply 100), a respective solenoid valve opens to allow the pressurized air to pass through the valve, through tubing 67 and passage 58, into the sample conditioning enclosure through a respective pneumatic signal line 118 (connected to the forward end of the manifold body by connectors 117 and to the stream selectors 130 by fitting 132, as shown in FIG. 1) located in the enclosure 20, and to a respective stream switching valve 130 in the sample conditioning enclosure.

As shown in FIG. 2, the assembly housing further comprises electronic circuitry for controlling power supplied to the solenoid valves and to components in the sample conditioning enclosure. The housing 32 includes a power supply 100 for supplying power to the solenoid valves and sensors or other electronic components located within the sample conditioning system. The power supply 100 may be connected to an external power supply 104 through wires 106. The external power supply 104 may provide, for example, 110V AC power that is converted to 24V DC power by power supply 100. The power supply 100 is connected to a high voltage control circuit 110 via wires 102. As discussed above, the power supply 100 provides power to the control circuit 110, which then powers the solenoids 62.

The electronic circuitry may also include a relatively low voltage circuit to provide low voltage power to sensors or other electronic equipment located within the sample conditioning system enclosure. As shown in FIG. 2, the low voltage circuit is provided as intrinsically safe barriers 70. The intrinsically safe barriers receive power from the control circuit 110 through leads 114 and convert the power received from the control circuit (which is not intrinsically safe) to an intrinsically safe power that is transmitted through leads 116 and across a second interface for connection to a low voltage component in the sample conditioning system. The second interface refers to the interface between the housing 31 and enclosure 20 through which the housing and enclosure may be electrically connected. The housing 31 and enclosure may need not be physically connected at the second interface except through the leads extending from the interior of housing 31 through a conduit or passage and into the enclosure 20 through a separate conduit or passage. For example, as shown in FIG. 2, leads 116 are disposed through a feed through element 75, which is disposed through a second opening (not illustrated) in the wall 32a of the housing assembly. Feed through element 75 provides a passage for the leads to the exterior of the assembly housing. The leads may be passed into the sample conditioning enclosure through a feed through element 115 disposed through an opening (not shown) in the wall 22b of the sample conditioning enclosure (FIG. 1).

The feed through elements 75 and 115 are not particularly limited and may be a piece of conduit made from a metal (e.g., steel), or a plastic or other polymeric material. If desired, the second opening in the assembly housing and the feed through element may have threaded surfaces to allow the feed through elements 75 and 115 to be threaded into the second opening of the assembly housing and enclosure, respectively.

FIGS. 2 and 3 show the housing being connected to the enclosure at the second interface by passing leads through separate conduits (passages) disposed in a wall of each of the housing 31 and enclosure 20. It will be appreciated that, if desired, the housing may be attached to the enclosure at the second interface by a single conduit attached to both the housing 31 and the enclosure 20 with the leads 116 passing therethrough. For example, feed through element 75 could be mounted through an opening in the wall of the enclosure.

It may be desirable to fluidically seal the interior (such as region 44 if the housing 31 includes an antechamber and/or region 40 if the housing does not include an antechamber) of the assembly housing 31 from the exterior at the second interface. Both the interior and exterior of the feed through element 75 may be sealed. Seals 76 may be provided about the exterior of the feed through element 75. The seals 76 may be provided on both the interior and exterior of the assembly housing. Seals may be provided by an o-ring or gasket (e.g., a rubber or polymeric seal) or by a caulk-like seal formed around the circumference of the feed through element (for example, with a silicone caulk). Additionally, the interior of the feed through element may be sealed around the leads 116 such as by a seal formed from any type of elastomer, plastic, or sealant. The interior of feed through element 75 may also be sealed by a pour seal.

A pneumatic control valve assembly that includes a low voltage circuit may be desirable for connecting to a sample conditioning system that will employ or require low voltage components located in the sample conditioning enclosure. Moreover, where a seal is provided at the first interface (and the second interface if desired), such an assembly allows the solenoids to be located in close proximity to a sample conditioning enclosure that may contain combustible fluids.

It will be appreciated that an assembly in accordance with the present invention may be used with a system that does not have electrical needs inside the enclosure 20. Thus, it will be appreciated that an assembly does not have to include a low voltage circuit or a second interface.

As shown in FIG. 2, the assembly housing includes a partition 38 disposed between the sidewalls 32a and 32b that separates the assembly housing into a main chamber and an antechamber 44. A feed through element 46 is disposed in partition 38, and the wires 112 connecting the solenoids to the control circuit are fed through the feed through element 46. The feed through element 46 may be a conduit or tube through which the wires are fed. As shown in FIG. 2, the power supply 100 and control circuit 110 are located in the antechamber 44. It will be appreciated that the housing 31 need not have an antechamber. The use of an antechamber may be desirable to provide an insulated barrier that insulates heat generated by the power components (e.g., power supply 100, control circuit 110, and barriers 70) from the components in the main chamber. It will be appreciated however that the housing assembly does not have to be separated into a main chamber and an antechamber and that all the components illustrated in FIG. 2 may be housed in a single chamber.

The housing 31 may include other features as desired for a particular purpose or intended use. It will be appreciated that the housing 31 may include a door or cover along the front of housing 31 to further seal the exterior from the interior. The door or cover also allows an operator access to the interior of the housing if maintenance is required or to monitor the operation of the solenoid valves. The door/cover may include a glass panel or clear plastic panel to allow the interior to be visually inspected. For example, solenoids may be used that include an LED that is illuminated when powered, and a window may allow an operator to see if a solenoid is not operating.

The components for both the pneumatic valve control assembly and the sample conditioning system may be made from any material suitable for a particular purpose or intended use. The housing 31 may be made from materials including, but not limited to, stainless steel, aluminum, a thermoplastic material, or the like. The solenoid mounting manifold may be made from aluminum, stainless steel, or the like. The manifold body may be made from metals such as aluminum, stainless steel, or the like. The leads 116 may be any suitable lead including, for example, a two wire transmitter that can send power to the sensors located in the enclosure 20 and can receive output signals from the sensors. The output signals may be transmitted through the control circuit 110 and through a transmitter 150 (and eventually converted to an output display).

The components to be located in the sample conditioning system enclosure are not particularly limited. The stream selectors may be, for example, any stream selector now known or later discovered. Suitable stream selectors include, for example, double block and bleed stream selectors or the stream selectors disclosed in U.S. Pat. No. 6,619,321, which is incorporated herein by reference in its entirety.

Although the invention has been shown and described with respect to one or more exemplary embodiments, it is appreciated that alterations and modifications may occur to others skilled in the art upon reading and understanding the specification and the annexed drawings without departing from the precepts involved herein. It is intended that all matter contained in the foregoing description shall be interpreted as illustrative and not in a limiting sense. In addition, while a particular feature may have been described with respect to only one or more several illustrated embodiments, such feature may be combined with one or more other features of the other embodiments, as may be desired and advantageous for any given or particular application.

1. A pneumatic valve control assembly for a sample conditioning system used to condition one or more fluid streams to be analyzed, the pneumatic valve control assembly comprising:
a housing being attachable to an enclosure of the sample conditioning system at a first interface;
at least one electrically operated pneumatic solenoid valve located in the housing, the solenoid valve having an inlet for connection to a source of pressurized air and an outlet connected to a flow passage extending through the first interface whereby pressurized air can be controllably supplied to a respective pneumatically controlled valve located in the enclosure of the sample conditioning system for pneumatically operating the pneumatically controlled valve; and
electronic circuitry located in the housing, the electronic circuitry including at least one relatively high voltage control circuit for controlling power supplied to the solenoid valve.

2. The assembly according to claim 1, wherein the interior of the assembly housing is fluidically sealed from the exterior at the first and second interfaces.

3. The assembly according to claim 1, wherein the housing is attachable to the enclosure at the first interface through a manifold body comprising one or more flow passages.

4. The assembly according to claim 3, wherein the manifold body comprises a forward end, and a rearward end, the forward end being configured for attachment to the enclosure of the sample conditioning system, and the rearward end being configured for attachment to the housing.

5. The assembly according to claim 4, wherein the manifold body comprises a bulkhead portion, and a flange portion, the flange portion being disposed adjacent the rearward end of the manifold body.

6. The assembly according to claim 5, wherein the bulkhead portion of the manifold body is disposed through an opening of the assembly housing and secured to the assembly housing.

7. The assembly according to claim 6, wherein the flange portion has an extent larger than the first opening of the assembly housing and is disposed within the interior of the housing assembly.

8. The assembly according to claim 7 comprising a seal member disposed between the flange portion and the first opening.

9. The assembly according to claim 3, wherein the manifold portion has a threaded exterior surface, and the manifold body is mounted to the assembly housing by a fastener threaded onto the threaded exterior of the bulkhead portion.

10. The assembly according to claim 1, wherein the assembly housing comprises an interior wall separating a main chamber and an antechamber, the electronic circuitry being located within the antechamber.

11. The assembly according to claim 1, wherein the electronic circuitry includes at least one relatively low voltage circuit connected to a lead that passes through a second interface for connection to at least one low voltage component located in the enclosure of the sample conditioning system.

12. A sample conditioning system for use in a chemical or other process facility for obtaining samples from one or more fluid streams to be analyzed, the system comprising:
an enclosure having an interior and an exterior, an opening through a wall thereof, and one or more stream pneumatically controlled valves; and
a pneumatic valve control assembly comprising:
a housing being attachable to the enclosure of the sample conditioning system at a first interface;
at least one electrically operated pneumatic solenoid valve located in the housing, the solenoid valve having an inlet for connection to a source of pressurized air and an outlet connected to a flow passage extending through the first interface whereby pressurized air can be controllably supplied to a respective pneumatically controlled valve located in the enclosure of the sample conditioning system for pneumatically operating the pneumatically controlled valve; and
electronic circuitry located in the housing, the electronic circuitry including at least one relatively high voltage control circuit for controlling power supplied to the solenoid valve.

13. The system according to claim 12, wherein the interior of the assembly housing is fluidically sealed from the exterior at the first and second interfaces.

14. The system according to claim 12, wherein the housing is attached to the enclosure at the first interface through a manifold body comprising one or more flow passages.

15. The system according to claim 14, wherein the manifold body comprises a forward end, and a rearward end, the forward end being configured for attachment to the enclosure of the sample conditioning system, and the rearward end being configured for attachment to the housing.

16. The system according to claim 15, wherein the forward end of the manifold body is disposed through an opening of the sample conditioning enclosure, and the rearward end of the manifold body is disposed through an opening at the assembly housing.

17. The system according to claim 16, wherein the manifold body comprises a bulkhead portion, and a flange portion, the flange portion being disposed adjacent the rearward end of the manifold body.

18. The system according to claim 17, wherein the flange portion has an extent larger than the first opening of the assembly housing and is disposed within the interior of the housing assembly.

19. The system according to claim 18 comprising a seal member disposed between the flange portion and the first opening.

20. The system according to claim 16, wherein the manifold portion has a threaded exterior surface, the manifold body is mounted to the assembly housing by a fastener threaded onto the threaded exterior of the bulkhead portion in a tightened engagement with the wall of the housing assembly, and the housing assembly is mounted to the sample conditioning enclosure by a fastener threaded into the threaded exterior of the bulkhead portion in a tightened engagement with the wall of the sample conditioning system enclosure.

21. The system according to claim 12, wherein the assembly housing comprises an interior wall separating a main chamber and an antechamber, the electronic circuitry being located within the antechamber.

22. The system according to claim 12, wherein the electronic circuitry includes at least one relatively low voltage circuit connected to a lead that passes through a second interface for connection to at least one low voltage component located in the enclosure of the sample conditioning system.

23. A method of attaching a pneumatic control valve assembly to a sample conditioning system used for conditioning one or more fluid streams to be analyzed, the method comprising:
providing a pneumatic control valve assembly comprising a housing and having (i) at least one electrically operated pneumatic solenoid valve, and (ii) electronic circuitry located within the housing, the solenoid valve having an inlet for connection to a source of pressurized air and an outlet for supplying pressurized air, the electronic circuitry including at least one relatively high voltage control circuit for controlling power supplied to the solenoid valves, and at least one relatively low voltage circuit connected to a lead;
attaching the housing to an enclosure of the sample condition at a first interface, the first interface having a flow passage extending therethrough, the pressurized air being controllably supplied through the first interface to a respective pneumatically controlled valve located in the enclosure; and
passing the lead connected to the low voltage control circuit through a second interface for connection to at least one low voltage component located in the enclosure of the sample conditioning system.

24. The method of claim 23, comprising providing a fluidic seal at at least one of the first and second interfaces to prevent the ingress of fluids into the interior of the housing.
